(19) United States
(12) Patent Application Publication
(10) Pub. No.: US 2008/0259137 A1
(43) Pub. Date: Oct. 23, 2008

(54) Ink Supply System for a Printer

(76) Inventor: Paul Geldenhuys, Cape Town (ZA)

Correspondence Address: DALINA LAW GROUP, P.C., 7910 IVANHOE AVE. #325, LA JOLLA, CA, 92037, US

(21) Appl. No.: 11/568,947

(22) PCT Filed: Apr. 25, 2005
(86) PCT No.: PCT/ZA2005/000061

§ 371 Date: Nov. 30, 2006

(51) Int. Cl. B41J 2/175

(52) U.S. Cl. 347/85

(57) ABSTRACT

An ink supply system (10) is disclosed which comprises a holder (12) for receiving an inverted ink bottle (B), an ink reservoir (22) and a flow path (14, 16) down which ink can flow from the bottle (B) to the reservoir (22). Air flows along said path from the reservoir to the bottle to replace ink which has run down the flow path. The flow path terminates intermediate the upper and lower ends of the reservoir. There is an air breather (32) and an ink delivery pipe (34) for connection to the print head of a printer. The vessel (24) has a lid (26) through which the flow pipe, the ink delivery pipe and the breather pass. In one form the holder and the lid are moulded integrally with one another.

### FIELD OF THE INVENTION

THIS INVENTION relates to an ink supply system for a printer.

### BACKGROUND TO THE INVENTION

Digital printers conventionally use ink cartridges. These usually contain 200 ml to 1000 ml of ink and most such cartridges cannot be refilled.

The present invention provides an ink supply system which enables printers to be supplied with ink from bottles and which hence obviates the need to use ink cartridges.

### BRIEF DESCRIPTION OF THE INVENTION

According to one aspect of the present invention there is provided an ink supply system which comprises a holder to which an inverted ink bottle can be fitted, an ink reservoir for containing ink, a flow path down which ink can flow from the bottle to a point intermediate the top and bottom of the reservoir and up which air can flow from the reservoir to the bottle as the bottle empties into the reservoir, an air breather opening which permits air to flow into and out of the upper end of the reservoir, and an ink delivery pipe which emerges from said reservoir for connection to the ink supply system of a printer.

The flow path can include flexible tubing of a length sufficient to permit said holder to be inverted whilst the tubing remains connected to the holder and the reservoir.

Said reservoir can comprise a vessel and a lid which fits on the vessel, said flow paths and said ink delivery pipe passing through said lid. Said breather opening can be constituted by a pipe passing through said lid.

Said flow path can comprise a pipe passing through said lid, and tubing extending from said pipes to said holder.

A filter can be provided at the end of said ink delivery pipe which is within the reservoir.

Said filter can comprise a length of tubular synthetic plastics material fitted to a hollow holder and itself fused closed along a transverse line at the end remote from the holder. It is also possible for such a filter to be incorporated into said ink delivery pipe.

In the preferred form there are two pipes constituting flow paths connecting the holder to the reservoir, one pipe terminating at a point in the reservoir which is below the point where the other pipe terminates.

Said other pipe can have its lower end lying in a plane which is skew with respect to the axis of the pipe.

Said lid and said holder can comprise a single moulded unit, said reservoir normally being below the unit and the holder facing upwardly, said reservoir and said unit being mounted for pivoting motion about an axis in such manner that the reservoir takes up an inverted position and a bottle in the holder hangs down from the holder.

In the form with a mould unit there can be two pipes constituting flow paths down which ink can flow from the bottle to the reservoir, one pipe terminating at a point in the reservoir which is below the point where the other pipe terminates. Said other pipe can have its end lying in a plane which is skew with respect to the axis of the pipe.

### BRIEF DESCRIPTION OF THE DRAWINGS

For a better understanding of the present invention, and to show how the same may be carried into effect, reference will now be made, by way of example, to the accompanying drawings in which:—

FIG. 1 diagrammatically illustrates an ink supply system in accordance with the present invention;

FIG. 2 illustrates an inline filter in “exploded” form;

FIG. 3 diagrammatically illustrated a further ink supply system in accordance with the present invention;

FIG. 4 illustrates the system of FIG. 3 inverted for ink bottle replacement purposes; and

FIGS. 5 and 6 diagrammatically illustrate another ink supply system respectively in its position of use and in its ink bottle replacement position.

### DETAILED DESCRIPTION OF THE DRAWINGS

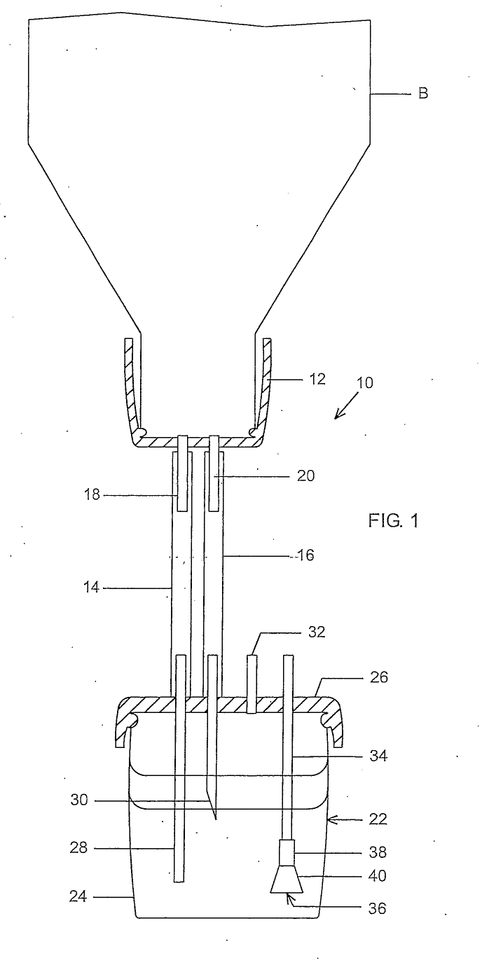

The ink supply system 10 illustrated in FIG. 1 comprises a bottle holder 12 which supports an open, inverted ink bottle B. The holder 12 can have formations, such as internal threading or bayonet type connectors, which are compatible with corresponding formations of the bottle B and releasably secure the bottle to the holder 12 in a leak proof manner.

Tubing 14 and 16 extends downwardly from the holder 12, the tubing 14, 16 being fitted to spigots 18 and 20 which pass through the holder 12 so that the tubing is in communication with the interior of a bottle in the holder. The tubing 14 and 16 is flexible.

The ink supply system further includes an ink reservoir 22 comprising a vessel 24 and a lid 26 which is a tight fit on the vessel.

Two pipes 28 and 30 pass through the lid 26, the tubing 14 and 16 being fitted to the ends of the pipes 28 and 30 which protrude above the lid 26.

The pipe 28 extends downwardly to a position close to the bottom of the vessel. The lower end of the pipe 30 is above the lower end of the pipe 28 and is cut off at an angle to the axis of the pipe.

A breather pipe 32 passes through the lid 26, the pipe 32 being open to atmosphere at its upper end.

An ink delivery pipe 34 also passes through the lid 26 and extends downwardly into the vessel 24. The tubing which connects the upper end of the pipe 34 to the ink supply system which in turn leads to the printer's print head has not been illustrated.

At the lower end of the pipe 34 there is a replaceable and disposable filter 36 for removing solid particles from the ink. The filter comprises a sleeve 38 of metal or synthetic plastics material and a short length of filter material 40 which is itself in tubular form. One end of the length of filter material 40 is fitted onto the sleeve 38 and the length of filter material 40 is closed by a transverse seal at the end thereof remote from the sleeve 38. The product known as sintered polypropylene can be used as the filter material 40.

The tubing 14, 16 is long enough to enable the holder 12 to be inverted from the position illustrated. The open side of the holder then faces downwardly. An empty bottle carried by the holder can be removed, and a full bottle fitted, without the necessity of inverting either bottle during this procedure.

The holder 12 with the upright full bottle suspended from it, is then returned to the illustrated inverted position. Bottle replacement can take place without switching-off the printer.

Ink initially flows from a full bottle B down the tubing 14 and 16 into the vessel 24 and air flows up the tubing to the bottle until the ink level in the vessel 24 reaches the lower end of the pipe 28. Air flow up the tubing 14 thus ceases but ink continues to flow down as air can still flow up the tubing 16. When the ink level reaches the pipe 30 and submerges its lower end, air can no longer flow up the tubing 16 and further flow of ink into the vessel 24 from the bottle B ceases due to the suction effect which results at the closed top of the bottle B. Flow cut-off occurs when the ink level entirely closes-off the angled, generally oval air inlet at the lower end of the pipe 30.

Whilst the printer is operating, ink is drawn through the length of filter material 40. Solid particles of above a predetermined size, depending on the rating of the filter material, are removed by the filter.

The ink level in the vessel 24 drops steadily until it exposes the lower end of the pipe 30 to the air in the upper part of the vessel 24. This allows air to flow into the bottle B, and hence permits ink to flow down to the vessel 24. Ink which flows in and flows out replaces, or is replaced by, air which flows through the breather pipe 32.

The angled end of the pipe 30 prevents a meniscus forming due to the surface tension of the ink. Formation of a meniscus in a pipe cut off at right angles to its axis prevents, or at least delays, the start of air flow up the tubing 16.

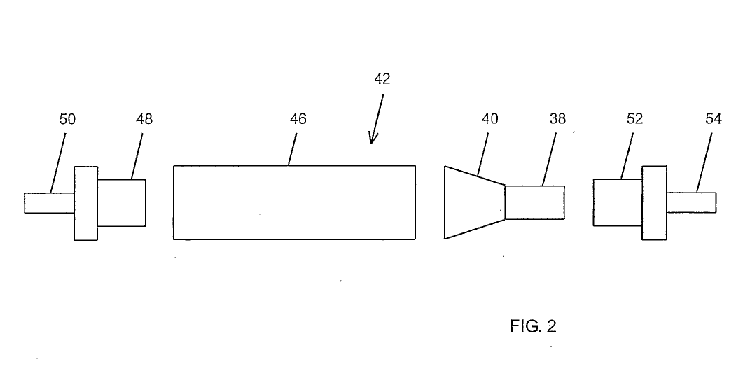

The filter 42 shown in FIG. 2 is intended for use in the ink delivery pipe. It can either replace, or be in addition to, the filter 36. The filter 42 comprises a synthetic plastics material tube 46. An end cap 48 including a spigot 50 is a tight fit in one end of the tube 46 and one section of the ink delivery tube fits onto the spigot 50. The filter 42 includes a further end cap 52 having a spigot 54. Another section of the ink delivery tubing fits on the spigot 54. The sleeve 38 fits in the end cap 52 with the material 40 within the tube 46. Ink, in flowing through the filter 42 from one section of the ink delivery tubing to the other, passes through the filter material 40.

The provision of the vessel 24 prevents pressure variations during replacement of the bottle B being transmitted to the print head. No valves, pumps or electronics are used in the system.

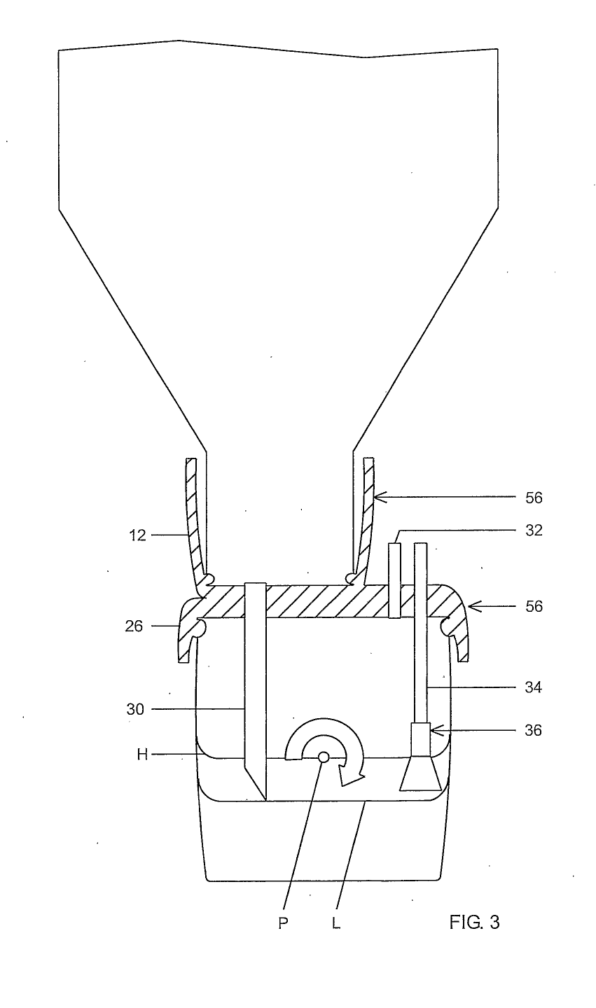

Referring now to FIG. 3, those parts of the ink supply system illustrated which are the same as those of FIGS. 1 and 2 have been designated with like reference numerals.

In this form the holder 12 and lid 26 are merged into a single unit designated 56. The pipe 28 is omitted and the pipe 30 is retained as are the breather pipe 32, the ink delivery pipe 34 and the filter 36.

The high and low ink levels are designated H and L respectively.

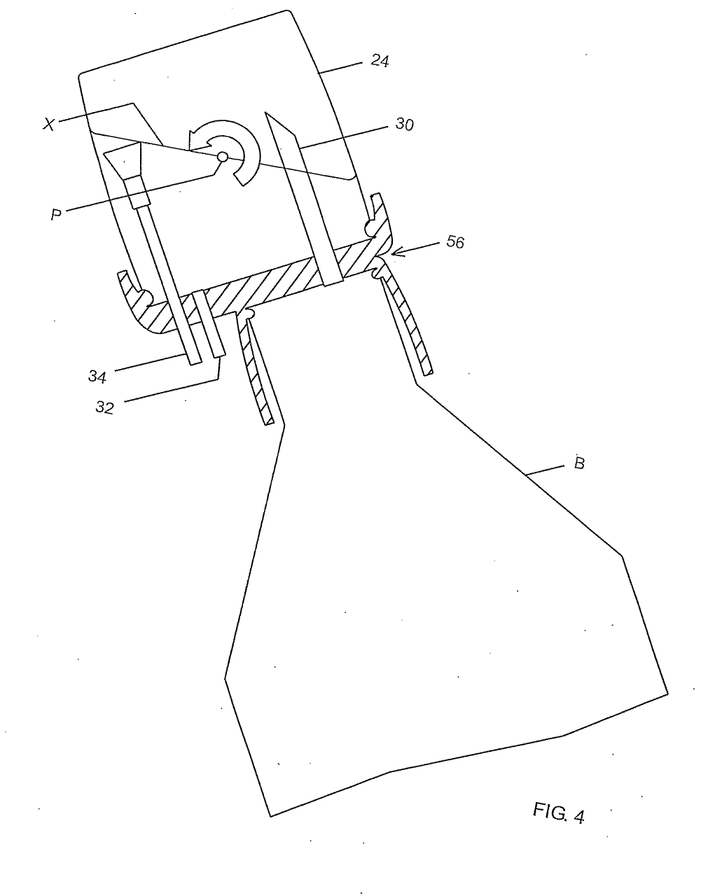

The entire structure illustrated in FIG. 3 is mounted in a cradle (not shown) which allows the structure to rotate about a pivot point P as shown by the curved arrow. The upright position is shown in FIG. 3 and the inverted position is shown in FIG. 4. The angle through which the structure turns is about 135 degrees.

The ink delivery tubing connected to the pipe 34 is long enough to permit this rotational movement. The breather pipe 32 is extended upwardly by tubing (not shown) to a level such that ink cannot run out of it when the structure is as shown in FIG. 4. The structure is only turned to the position of FIG. 4 when the ink bottle is empty.

Once the structure is tilted from the position shown in FIG. 3 to the position shown in FIG. 4, the ink in the vessel 24 lies below the line X. This is high enough to permit flow of ink to the print heads to continue but not high enough for the ink to flow into the pipe 30. The tubing connected to the breather pipe 32 extends upwardly to above level X.

The bottle B can thus be unscrewed from the unit 56 and a new bottle screwed in. The structure is then returned to the position shown in FIG. 3.

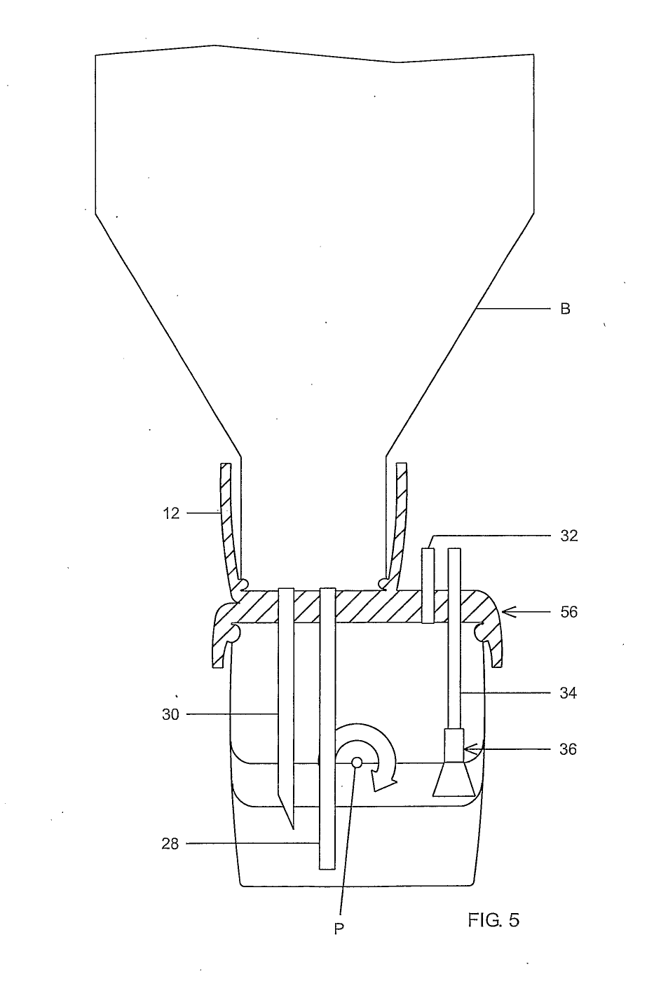

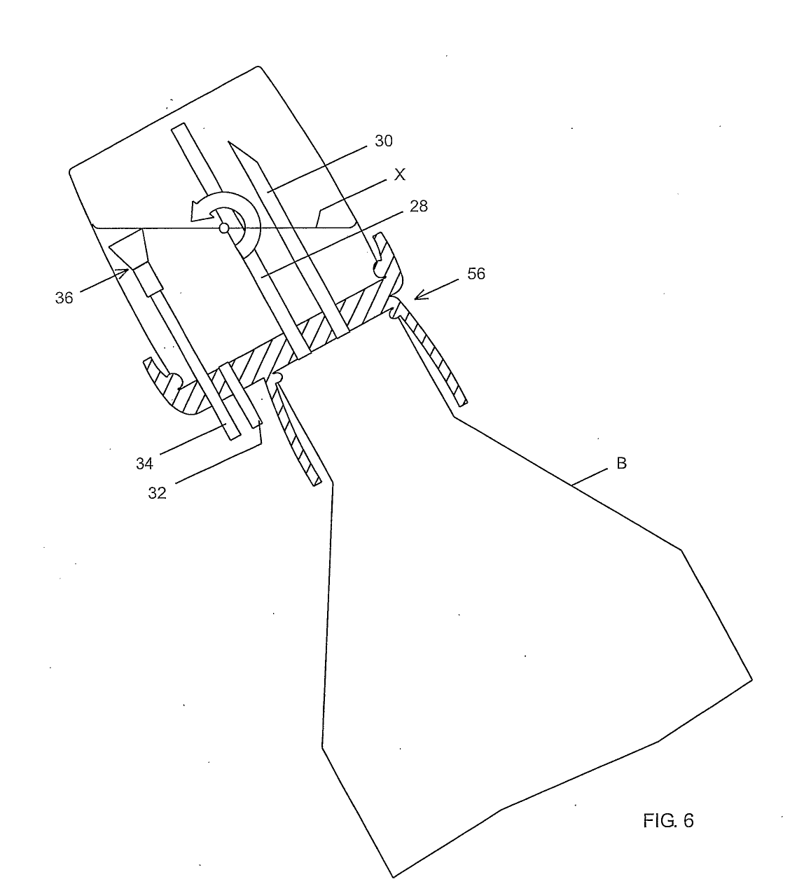

The system of FIGS. 5 and 6 incorporates most of the components of FIGS. 1 and 2 as well as the unit 56. The same reference numerals have been used for those components of FIGS. 3 and 4 which have corresponding parts in FIG. 1. The system is shown inverted in FIG. 6 and it will be noted that the open ends of the pipes 28 and 30 are both above the ink level.

1-12. (canceled)

13. An ink supply system which comprises a holder to which an inverted ink bottle can be fitted, an ink reservoir for containing ink, a flow path down which ink can flow from said inverted ink bottle to a point intermediate between a top and bottom of said ink reservoir and up which air can flow from said ink reservoir to said inverted bottle as said inverted bottle empties into said ink reservoir, an air breather opening which permits air to flow into and out of an upper end of said ink reservoir, and an ink delivery pipe which emerges from said ink reservoir for connection to said ink supply system of a printer.

14. The ink supply system as claimed in claim 13, wherein said flow path includes flexible tubing of a length sufficient to permit said holder to be inverted whilst said flexible tubing remains connected to said holder and said ink reservoir.

15. The ink supply system as claimed in claim 13, wherein said reservoir comprises a vessel and a lid which fits on said vessel, said flow path and said ink delivery pipe passing through said lid.

16. The ink supply system as claimed in claim 15, wherein said air breather opening is constituted by a pipe passing through said lid.

17. The ink supply system as claimed in claim 16, wherein said flow path comprises a pipe passing through said lid, and tubing extending from said pipe to said holder.

18. The ink supply system as claimed in claim 13, wherein a filter is provided at that end of said ink delivery pipe which is within said ink reservoir.

19. The ink supply system as claimed in claim 18, wherein said filter comprises a length of tubular synthetic plastics material fitted to a hollow holder and itself fused closed along a transverse line at an end remote from said holder.

20. The ink supply system as claimed in claim 13 and including two pipes constituting flow paths connecting said holder to said ink reservoir, one pipe terminating at a point in said ink reservoir which is below a point where a second of said two pipes terminates.

21. The ink supply as claimed in claim 20, wherein said second of said two pipes has its lower end lying in a plane which is skew with respect to an axis of said one pipe.

22. The ink supply system as claimed in claim 13, wherein said ink reservoir comprises a vessel and a lid, and wherein said lid and said holder are molded as a single unit, said reservoir normally being below said single unit and said holder facing upwardly, said reservoir and said single unit being mounted for pivoting motion about an axis in such manner that said ink reservoir takes up an inverted position and a bottle in said holder hangs down from said holder.

23. The ink supply system as claimed in claim 22, and including two pipes constituting flow paths down which ink can flow from said bottle to said ink reservoir, one pipe terminating at a point in said ink reservoir which is below a point where a second of said two pipes terminates.

24. The ink supply system as claimed in claim 23, wherein said second of said two pipes has its lower end lying in a plane which is skew with respect to an axis of said one pipe.
